(19) United States
(12) Patent Application Publication
(10) Pub. No.: US 2024/0410435 A1
(43) Pub. Date: Dec. 12, 2024

(54) ELECTROMECHANICAL BRAKE

(71) Applicant: Robert Bosch GmbH, Stuttgart (DE)

(72) Inventors: Bernd Lutz, Kempten (DE); Dietmar Kratzer, Tamm (DE); Felix Zimmermann, Asperg (DE); Mark Boehm, Lehrensteinsfeld (DE); Martin Winkler, Sonthofen (DE)

(21) Appl. No.: 18/673,620

(22) Filed: May 24, 2024

(30) Foreign Application Priority Data
Jun. 6, 2023 (DE) 10 2023 205 265.2

(51) Int. Cl. F16D 65/18; B60T 13/74; F16D 66/00; F16D 121/24; F16D 127/06

(52) U.S. Cl. CPC F16D 65/18; B60T 13/746; F16D 2066/003; F16D 2121/24; F16D 2127/06

(57) ABSTRACT

An electromechanical brake for braking a motor vehicle. The electromechanical brake includes an electric motor having a shaft via which a brake piston can be axially moved for braking. A disk is arranged on the shaft and has a plurality of recesses arranged in the circumferential direction. In addition, the electromechanical brake includes a magnetic actuator which axially moves a pin so that one end of the pin interacts with the recesses of the disk and blocks a movement of the shaft in a brake release direction, whereby the pin can be held in a bistable manner. The magnetic actuator and a control unit, for controlling the electric motor and the magnetic actuator, are arranged in the axial direction relative to the electric motor, and the pin is movable parallel to the shaft.

### FIELD

The present invention relates to an electromechanical brake for braking a motor vehicle. In addition, the present invention relates to a motor vehicle having such an electromechanical brake.

### BACKGROUND INFORMATION

The service brake is usually a brake that uses brake fluid to press a brake piston together with a brake pad onto a brake disk in order to brake the vehicle. The parking brake, on the other hand, is designed as an electromechanical brake. As part of the increasing electrification of motor vehicle components, the service brake is also intended to be designed as an electromechanical brake, thereby making it possible to dispense with brake fluid and the associated complex valve and line structure. Such an electromechanical brake could also significantly reduce maintenance requirements.

German Patent Application No. DE 102 34 848 A1 describes an electromechanical brake that can be locked in an actuated position using a locking device. A service and parking brake is thus created. The brake is designed as a disk brake, which has a brake caliper on which an electric motor and gearing are arranged. The motor has a stator and a rotor, wherein the rotor is designed as a screw mechanism which converts a rotational movement into a translational movement for pressing a brake pad against a brake disk. Connected to the rotor is a ratchet wheel which has a plurality of sawtooth-shaped teeth. A pawl which can be held in a bistable manner by an electromagnet and a permanent magnet is arranged on the brake caliper in the region of the ratchet wheel and interacts with the ratchet wheel to form a parking brake.

The problem addressed by the present invention is to provide an electromechanical brake having a parking brake with which assembly outlay and space requirements can be reduced.

This problem may be solved by an electromechanical brake having features of the present invention. Preferred embodiments of the present invention are disclosed herein.

### SUMMARY

The present invention provides an electromechanical brake for braking a motor vehicle. According to an example embodiment of the present invention, the electromechanical brake comprises an electric motor having a shaft via which a brake piston can be axially moved for braking. A disk having a plurality of recesses arranged in the circumferential direction is arranged on the shaft, and the brake further comprises a magnetic actuator which axially moves a pin so that one end of the pin interacts with the recesses of the disk and blocks a movement of the shaft in a brake release direction. The pin can thus be held in a bistable manner. The magnetic actuator and a control unit, for controlling the electric motor and the magnetic actuator, are arranged in the axial direction relative to the electric motor, and the pin is movable parallel to the shaft.

Due to the bistability, the pin can be held stable in two positions without any energization. The positions correspond to the driving position and a parking position. This means that only electricity is needed to move the pin between the stable positions. By a movement in the brake release direction being blocked, a parking brake is formed, so that the motor vehicle can be parked with the brakes applied. An axial arrangement of the control unit and the magnetic actuator has the advantage that the space requirement can be kept low. In addition, the axial arrangement of the magnetic actuator allows it to be connected directly to the control unit. Outlay on cabling can thus be kept low. In addition, this reduces assembly outlay and thus the costs for such an electromechanical brake.

In a preferred embodiment of the present invention, the disk is designed as a toothed disk. A toothed disk has teeth on an outer circumference, between which teeth recesses are formed. By means of a toothed disk it is therefore easy to provide recesses for the pin. In addition, toothed discs are widely available on the market, so that no separate part has to be developed, thus saving costs. Advantageously, the toothed disk is designed as a sheet metal part. A sheet metal part can be manufactured easily and economically. In addition, such a sheet metal part can save material costs and weight due to its thin-walled design.

In a further preferred embodiment of the present invention, the disk is designed in the form of an axial impeller. An axial impeller is understood to be a component which has fan blades which are angled axially at one end in the circumferential direction. Such an axial impeller can move air in an axial direction. Due to the angled fan blades, a movement of the axial impeller can be easily blocked by the pin. Advantageously, the axial impeller is formed from a sheet metal part so that the advantages described above can be achieved.

According to an example embodiment of the present invention, preferably, the pin has a groove in the region of an axial end, which groove interacts with the teeth of the toothed disk or the fan blades of the axial impeller so that the pin can be held in a stable position. The groove is advantageously designed as a circumferential groove on the pin. The teeth or the fan blades engage in the groove, thus easily creating a stable position for the pin. The pin can therefore hold the brake in a braked position when de-energized.

According to an example embodiment of the present invention, preferably, an axial end of the pin pointing towards the disk has a conical tip. Such a tip can make insertion into the recesses easier.

In an advantageous development of the present invention, the pin has, at one axial end, a widening which interacts with the teeth of the toothed disk or the fan blades of the axial impeller so that the pin can be held in a stable position. A widening in this case is an increase in the diameter at the axial end. Such a widening can also keep the pin stable.

Advantageously, according to an example embodiment of the present invention, the pin is designed to have several parts in its axial length. The parts are joined during assembly. This allows the widening or the groove to be manufactured separately, thus simplifying production. In addition, assembly is simplified by the reduced length of the pin.

Advantageously, according to an example embodiment of the present invention, fan blades formed by the axial impeller are angled in a brake release rotational direction of the axial impeller towards the magnetic actuator so that, via the fan blades, a compressive force in a braking rotational direction can be applied to the pin in the direction of the magnetic actuator. The brake release rotational direction is a direction of rotation of the axial impeller in which the brake piston is moved back so that an applied braking force is reduced. The brake is correspondingly released in this direction. By means of a rotation of the axial impeller in a braking rotational direction, the pin slides over a surface of the next fan blade and is thereby pushed towards the magnetic actuator. This means that it is only necessary to energize the magnetic actuator in order to move the pin axially in the direction of the disk. The angled fan blades can also be used in combination with a pin retracted by a spring. In this case, the angled fan blades would provide the spring with a redundancy, for example should the pin have jammed and not be able to be retracted by the spring.

In a further advantageous embodiment of the present invention, the magnetic actuator has a latching mechanism, via which the pin can be held in a bistable manner. Such a latching mechanism means that a groove or widening on the pin can be dispensed with. The pin is therefore held stably in the two positions only by the latching mechanism. Advantageously, the latching mechanism is made of plastics. The latching mechanism can therefore be manufactured simply, cost-effectively and with a low weight.

According to an expedient embodiment of the present invention, a speed sensor is arranged in the control unit for measuring a speed of the electric motor. Due to the axial arrangement of the control unit in relation to the electric motor, the control unit is arranged at one end of the shaft of the electric motor. This makes it possible to position the speed sensor within the control unit, thus eliminating the need for wiring to the speed sensor. This considerably simplifies the outlay on assembly.

According to a further expedient embodiment of the present invention, the magnetic actuator is arranged in a hole in a housing of the electromechanical brake. The magnetic actuator is completely or at least partially arranged in the hole.

Preferably, the magnetic actuator is completely arranged in the hole. This reduces the space required for the magnetic actuator. Such an electromechanical brake can therefore have a smaller design.

Additionally, a motor vehicle is provided which comprises the electromechanical brake according to the present invention. With such an motor vehicle, the advantages described above are achieved.

Exemplary embodiments of the present invention are illustrated in the figures and explained in more detail in the following description.

### BRIEF DESCRIPTION OF THE DRAWINGS

FIG. 1 shows a perspective view of an electromechanical brake according to an exemplary embodiment of the present invention.

FIG. 2 shows a partial sectional view of the electromechanical brake according to an exemplary embodiment of the present invention.

FIG. 3A shows a plan view of an axial impeller with a pin according to an exemplary embodiment of the present invention.

FIG. 3B shows a side view of the axial impeller with a pin according to FIG. 3A.

FIG. 4A shows an exemplary embodiment of a latching mechanism in a driving position of the motor vehicle, according to the present invention.

FIG. 4B shows the latching mechanism according to FIG. 4A in an energized position of the magnetic actuator.

FIG. 4C shows the latching mechanism according to FIG. 4A in a braking position of the motor vehicle.

### DETAILED DESCRIPTION OF EXAMPLE EMBODIMENTS

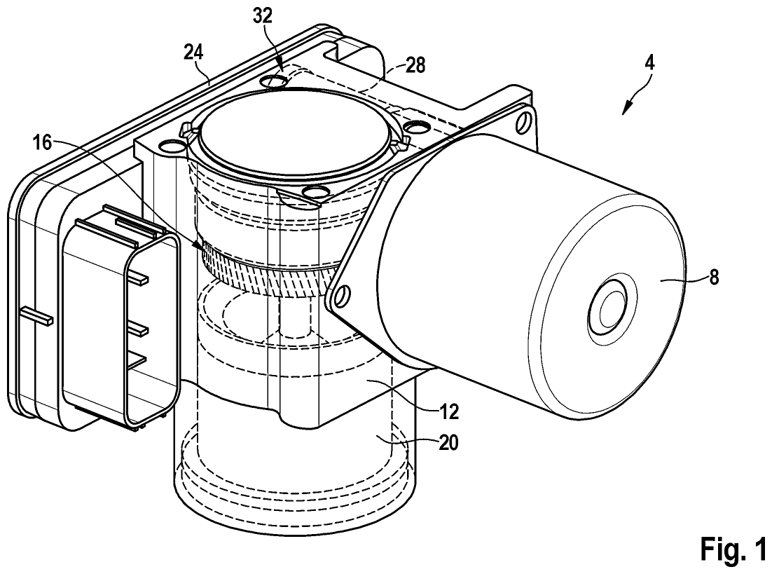

FIG. 1 shows a perspective view of an electromechanical brake 4 according to an exemplary embodiment of the present invention. The electromechanical brake 4 comprises an electric motor 8 which is connected to a housing 12. A gear unit 16 arranged in the housing 12 can be driven via the electric motor 8. A brake piston 20 provided in the housing 12 is operatively connected to the gear unit 16 so that the brake piston 20 can be axially moved by the drive of the electric motor 8 in order to apply a braking force.

A control unit 24 is arranged on the housing 12 on a side of the housing 12 facing away from the electric motor 8. The electric motor 8 can be controlled via this control unit 24. A hole 28, in which a magnetic actuator 32 is provided, is formed in the housing 12. One end of the magnetic actuator 32 is contacted via the control unit 24 and is controlled via the same.

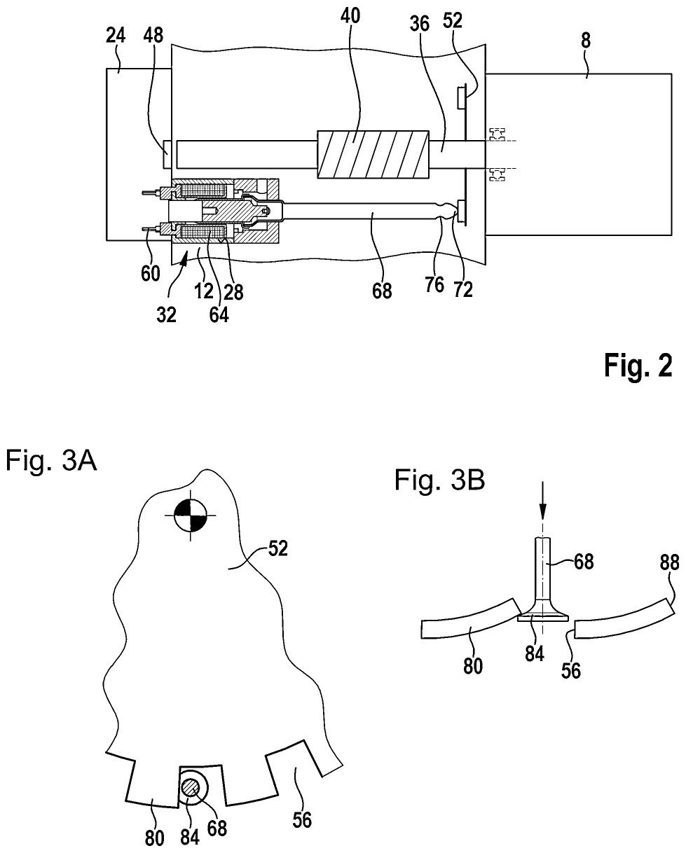

FIG. 2 shows a partial sectional view of the electromechanical brake 4 according to an exemplary embodiment of the present invention. In this figure, a shaft 36 of the electric motor 8 is shown, on which shaft a worm 40 is formed for driving the gear unit 16. The shaft 36 is mounted at an opposite end of the housing 12. In the axial direction relative to the electric motor 8, the control unit 24, via which the magnetic actuator 32 and the electric motor 8 can be controlled, is arranged on the housing 12. A speed sensor 48 is arranged in the control unit 24, via which sensor a speed of the shaft 36 can be measured.

In addition, a disk 52 is non-rotatably mounted on the shaft 36 and has a plurality of recesses 56 (see FIG. 3A). In this figure, the magnetic actuator 32 is shown in the hole 28. The magnetic actuator 32 is also arranged in the axial direction relative to the electric motor 8. In addition, the magnetic actuator 32 is provided below the control unit 24 in the hole 28 in the housing 12. As a result, contacts 60 of the magnetic actuator 32 project directly into the control unit 24 so that they can be connected to the control unit 24 without any wiring outlay.

The magnetic actuator 32 has a coil 64, via which a pin 68 can be moved in the axial direction of the magnetic actuator 32. The pin 68 is arranged parallel to the shaft 36. At an axial end pointing towards the disk 52, the pin 68 has a conical tip 72 which makes it easier to find the recess 56. In the region of the axial end, a groove 76 is additionally formed, into which fan blades 80 of the disk 52, here taking the form of an axial impeller (see FIGS. 3A and 3B), engage. Although the present invention is explained here with reference to a disk 52 taking the form of an axial impeller, the disk 52 can also take the form of a toothed disk. Due to the fan blades 80 engaged in the groove 76, the pin 68 is prevented from being retracted. The pin 68 is therefore held stably in this position. After activation of the brake, the pin 68 is moved axially towards the disk 52 so that the disk 52 blocks the brake and thereby forms a parking brake.

FIG. 3B shows a side view of the axial impeller 52 with a pin 68 according to FIG. 3A. The pin 68 differs from the pin 68 shown in FIG. 2 in that, instead of a groove 76, a widening 84 is formed at the axial end. By means of this widening 84, the pin 68 can also be held stably in one position via the fan blades 80. FIG. 3B additionally shows how the fan blades 80 are formed. Here, the fan blades 80 are angled in the circumferential direction. In other words, in the circumferential direction, one end of the fan blades 80 extends in the axial direction. The fan blades 80 are designed such that, in the direction of rotation of the disk, which corresponds to a brake release rotational direction, an angled end 88 of the fan blade 80 strikes the pin 68 axially moved towards the electric motor 8. This prevents the parking brake from being released.

After the pin 68 is locked, it is possible to release the pin 68 by rotating the axial impeller 52 in a direction in which the brake is applied. The axial end of the pin 68 slides on an upper side of the fan blade 80. Due to the angled design of the fan blades 80, the pin 68 is axially moved towards the magnetic actuator 32. This enables a rotation of the axial impeller 52 in a brake release direction.

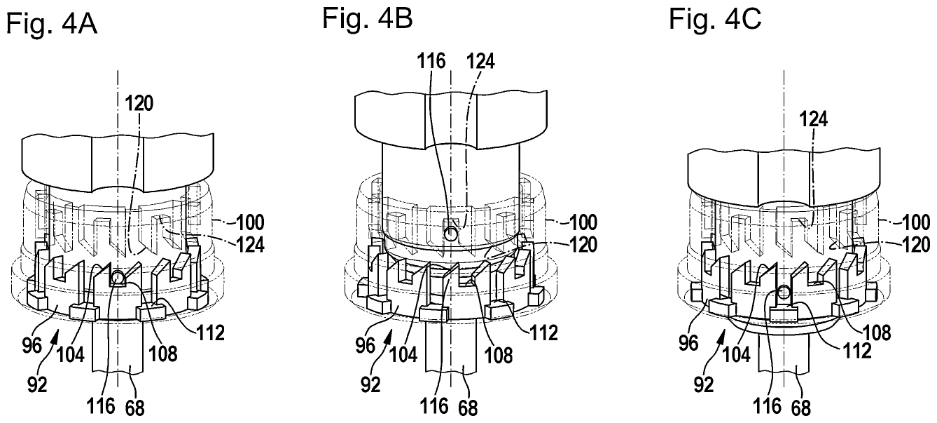

FIG. 4A shows an exemplary embodiment of a latching mechanism 92 in a driving position of the motor vehicle. In the driving position, the pin 68 is at a distance from the disk 52 so that a rotational movement of the disk 52 is possible. The latching mechanism 92 is arranged between the magnetic actuator 32 and the pin 68. The latching mechanism 92 is formed from an inner ring 96 and an outer ring 100 that surrounds the inner ring 96. The inner ring 96 has a sawtooth-shaped structure. Between the saw teeth 104, a small recess 108 and a large recess 112 are alternately formed. The outer ring 100 has a sawtooth-shaped structure with alternating recesses similar to the inner ring 96. The sawtooth-shaped structures of the inner and outer rings 96, 100 are spaced apart from each other in the axial direction.

A pin 116 extending in the radial direction is arranged on the pin 68 in the region of the latching mechanism 92. The pin 116 is designed such that it can interact not only with the sawtooth-shaped structure of the inner ring 96 but also with the sawtooth-shaped structure of the outer ring 100. In the position shown in FIG. 4A, the pin 116 lies in the small recess 108 of the inner ring 96. As a result, the pin 68 is held stably in a position at a distance from the disk 52.

FIG. 4B shows the latching mechanism 92 according to FIG. 4A in an energized position of the magnetic actuator 32. The magnetic actuator 32 is energized in such a way that the pin 68 is pulled in a direction opposite to the disk 52. The pin 116 has been pulled over a sawtooth 120 of the outer ring 100 into a recess 124 of the outer ring 100. This has caused the pin 68 to rotate by an angular amount.

In FIG. 4C, the latching mechanism 92 according to FIG. 4A is shown in a braking position of the motor vehicle. In this position, the pin 116 is arranged in the large recess 112. Starting from the position in FIG. 4C, the pin 116 is moved over an incline of the sawtooth 104 of the inner ring 96 into the large recess 112. In this position, the pin 68 is moved towards the disk 52 so that the disk 52 can be blocked via the pin 68. In the position shown in FIG. 4C, the pin 68 can also be held stably so that bistability is formed simply via the latching mechanism 92.

1-10. (canceled)

11. An electromechanical brake for braking a motor vehicle, comprising:
an electric motor having a shaft via which a brake piston can be axially moved for braking;
a disk having a plurality of recesses arranged in a circumferential direction, arranged on the shaft; and
a magnetic actuator which axially moves a pin so that one end of the pin interacts with the recesses of the disk and blocks a movement of the shaft in a brake release direction, wherein the pin can be held in a bistable manner;
wherein the magnetic actuator and a control unit, for controlling the electric motor and the magnetic actuator, are arranged in an axial direction relative to the electric motor, and the pin is movable parallel to the shaft.

12. The electromechanical brake according to claim 11, wherein the disk is a toothed disk.

13. The electromechanical brake according to claim 11, wherein the disk is an axial impeller.

14. The electromechanical brake according to claim 12, wherein, in a region of an axial end, the pin has a groove which interacts with the teeth of the toothed disk so that the pin can be held in a stable position.

15. The electromechanical brake according to claim 13, wherein, in a region of an axial end, the pin has a groove which interacts with fan blades of the axial impeller so that the pin can be held in a stable position.

16. The electromechanical brake according to claim 12, wherein, at one axial end, the pin has a widening which interacts with teeth of the toothed disk so that the pin can be held in a stable position.

17. The electromechanical brake according to claim 13, wherein, at one axial end, the pin has a widening which interacts with fan blades of the axial impeller so that the pin can be held in a stable position.

18. The electromechanical brake according to claim 15, wherein the fan blades of the axial impeller are angled in a brake release rotation direction of the axial impeller towards the magnetic actuator so that, via the fan blades, a compressive force in a braking rotation direction can be applied to the pin in a direction of the magnetic actuator.

19. The electromechanical brake according to claim 11, wherein the magnetic actuator has a latching mechanism using which the pin can be held in a bistable manner.

20. The electromechanical brake according to claim 11, wherein a speed sensor is arranged in the control unit for measuring a speed of the electric motor.

21. The electromechanical brake according to claim 11, wherein the magnetic actuator is arranged in a hole in a housing of the electromechanical brake.

22. A motor vehicle, comprising:
an electromechanical brake for braking the motor vehicle, the electromechanical brake including:
an electric motor having a shaft via which a brake piston can be axially moved for braking,
a disk having a plurality of recesses arranged in a circumferential direction, arranged on the shaft, and
a magnetic actuator which axially moves a pin so that one end of the pin interacts with the recesses of the disk and blocks a movement of the shaft in a brake release direction, wherein the pin can be held in a bistable manner,
wherein the magnetic actuator and a control unit, for controlling the electric motor and the magnetic actuator, are arranged in an axial direction relative to the electric motor, and the pin is movable parallel to the shaft.
